(19) United States
(12) Patent Application Publication
(10) Pub. No.: US 2019/0007300 A1
(43) Pub. Date: Jan. 3, 2019

(54) DEADLOCK-FREE ROUTING IN PARTIAL MESH NETWORKS

(71) Applicant: QUALCOMM Incorporated, San Diego, CA (US)

(72) Inventors: Ravi Kiran KARANAM, Cary, NC (US); Thomas BASNIGHT, Raleigh, NC (US); Senyo APEWOKIN, Austin, TX (US); Oluleye OLORODE, Pflugerville, TX (US)

(21) Appl. No.: 15/640,451

(22) Filed: Jun. 30, 2017

(51) Int. Cl. H04L 12/707; H04L 12/863

(52) U.S. Cl. CPC H04L 45/22; H04L 47/6235

(57) ABSTRACT

Systems and methods for of deadlock-free routing in a partial two-dimensional (2D) mesh network include at least one restricted path in a turn model for deadlock-free routing of a data packet from a first node to a second node of the partial mesh network. The at least one restricted path is enabled with a terminating channel ending in the second node and used for routing the data packet through the terminating channel. The terminating channel may include a physical terminating channel or a virtual terminating channel.

### FIELD OF DISCLOSURE

Disclosed aspects are directed to networks in processing systems. More specifically, exemplary aspects are directed to routing data packets in mesh networks, particularly, partial mesh networks, while avoiding deadlocks.

### BACKGROUND

Processing systems may employ different network architectures for transport of data between different components such as processors, memory elements, input/output ports, interface structures, switching elements, etc. The network may be implemented with various links or channels on to which data packets may be routed through routers or nodes. The topologies formed by the channels and nodes of a network may be classified into known categories such as a ring, mesh, star, etc. As the number of nodes in a processing system, e.g., a system-on-chip (SoC), increase, network topologies such as a two dimensional (2D) mesh are becoming increasingly popular due to their ability to meet performance goals.

FIG. 1A illustrates an example 5×5 full 2D mesh network 100 with 5 rows and 5 columns of nodes (labeled 00-44 as shown) disposed in respective X and Y directions, respectively. In full 2D mesh network 100, routing of data packets between the illustrated 5×5 nodes may be achieved by constructing a channel dependency graph (CDG) to achieve an optimal route. An objective of the CDG is to prevent cycles, also referred to as a “deadlock”, from forming in the transmission path of a data packet between two nodes. A deadlock arises when a link between nodes in the transmission path of the data packet is dependent upon itself, which can lead to a stall in the transmission, cause data errors, and in some cases, problems which can permeate across the entire network or processing system.

In various implementations, CDGs may be constructed to achieve deadlock-free routing by using deterministic routing models such as “turn models” which place restrictions on the transmission path. Turn models will be explained with reference to FIGS. 1B-D.

In FIG. 1B, channels or links between nodes of a network such as full 2D mesh network 100 are shown using two conceptual cycles 102 and 104. Cycle 102 may be a clockwise cycle with four turns 102a-d and cycle 104 may be an anti-clockwise cycle with four turns 104a-d. A data packet traversing in either one of these cycles 102 or 104 may encounter a deadlock. To free the data packet from a deadlock, restrictions may be placed in one or more of the abovementioned turns of cycles 102/104.

In FIG. 1C, a first type of known restriction on turns is shown for two cycles 106 and 108, comprising turns 106a-d in the clockwise direction and turns 108a-d in the anti-clockwise direction, respectively. In both of these cycles, two of the four turns are restricted, in the sense that packets will be prevented from making those turns. Specifically, in cycle 106, turns 106a and 106c are shown with dashed lines to indicate that these turns are restricted. Similarly, in cycle 108, turns 108a and 108c are shown to be restricted. This type of a turn model implemented in cycles 106 and 108 is known in the art as a dimension-order routing (DOR). By restricting two out of four possible turns in the path of a data packet, the DOR prevents cycles from forming in the path of the data packet. Viewed differently, the DOR places conditions on packet routing, such as requiring a packet which is transmitted from a source node to always travel in the X direction first as much as needed or possible and then switch to travelling in the Y direction to reach the destination node, free from deadlocks. While the DOR achieves deadlock-free routing, it also imposes substantial restrictions on the possible paths that a data packet may follow in a network such as full 2D mesh network 100, which may lead to longer paths and corresponding increases in delays and resource consumptions.

With reference to FIGS. 1D-F, less restrictive turn models than the DOR with only one out of the four possible turns being restricted, are shown (with reference labels explicitly shown for only the restricted turns, for the sake of clarity). Specifically, FIG. 1D illustrates a “west first” model, wherein turns 110c and 112b (which cause a data packet to first turn into a west direction (with the X direction of FIG. 1A analogously indicating east)) of cycles 110 and 112, respectively, are restricted. FIG. 1E illustrates a “north last” model, wherein turns 114a and 116b (which cause a data packet to last turn into a north direction (with the Y direction of FIG. 1A analogously indicating north)) of cycles 114 and 116, respectively, are restricted. FIG. 1F illustrates a “negative first” model, wherein turns 118c and 120b (which cause a data packet to first turn into a negative direction (with the X and Y directions of FIG. 1A analogously indicating positive directions)) of cycles 110 and 112, respectively, are restricted. As can be recognized, each one of the turn models shown in FIGS. 1D-F represent one of four possible turn models of a similar category, which means that there may be 12 possible routing algorithms with one turn restriction.

While a CDG for the full 2D mesh network 100 of FIG. 1A may be implemented using one of the various turn models shown in FIGS. 1B-F to achieve deadlock-free routing, it is recognized that not all SoCs or network designs may be capable of supporting the implementation of a full 2D mesh. For example, there may be physical limitations such as the availability of metal layers and die size constraints on an SoC which restricts the possibility of implementing a full 2D mesh topology. In such cases, alternative network topologies are chosen in conventional implementations, by removing some nodes or routers to result in partial mesh topologies. While partial mesh networks may solve the problems associated with limited physical resources and routing limitations on a particular SoC, they may not support the various turn models which allow deadlock-free routing on a full 2D mesh. This means that routing paths between some nodes, if possible, may not be optimal or follow a minimal routing distance, leading to inefficiencies.

FIGS. 2A-C illustrate example partial 2D mesh networks 202, 204, and 206, respectively, with certain links and/or nodes removed in comparison to the full 2D mesh network 100 of FIG. 1A. For example, considering partial 2D mesh network 202 of FIG. 2A, it is seen that the links or channels between nodes (01, 11, 21, 31, 41) as well as those between nodes (03, 13, 23, 33, 43) have been removed. If a turn model such as DOR with two restricted turns were to be applied to partial 2D mesh network 202, navigation from node 01->11 as part of the DOR would not be possible since this path requires travel in the X direction after traversal in the Y direction (which is not supported by DOR, as seen from FIG. 1C). Similarly, turn models with a single restricted turn such as the west first model of FIG. 1D may not provide an efficient traversal of a path from node 03->11. For example, in a conventional implementation of partial 2D mesh network 202 a west first turn model may entail a suboptimal path 208 comprising the traversal through nodes: 03->02->01->00->10->11, even though a shorter path exists (shown with dashed lines as path 210 comprising the traversal through nodes: 03->02->12->11).

Accordingly, it is seen that although partial 2D mesh networks may be desirable or required in some cases, conventional implementations of partial 2D mesh networks result in a tradeoff which fails to provide minimal path routing when turn restrictions are put in place to prevent deadlocks.

### SUMMARY

Exemplary aspects are directed to systems and methods for of deadlock-free routing in a partial two-dimensional (2D) mesh network include at least one restricted path in a turn model for deadlock-free routing of a data packet from a first node to a second node of the partial mesh network. The at least one restricted path is enabled with a terminating channel ending in the second node and used for routing the data packet through the terminating channel The terminating channel may include a physical terminating channel or a virtual terminating channel.

For example, an exemplary aspect is directed to a method of deadlock-free routing in a partial mesh network, the method comprising determining at least one restricted path in a turn model for deadlock-free routing of a data packet from a first node to a second node of the partial mesh network, enabling the at least one restricted path with a terminating channel ending in the second node, and routing the data packet through the terminating channel.

Another exemplary aspect is directed to an apparatus comprising a partial mesh network comprising at least a first node and a second node. The partial mesh network is configured to determine at least one restricted path in a turn model for deadlock-free routing of a data packet from the first node to the second, enable the at least one restricted path with a terminating channel ending in the second node, and route the data packet through the terminating channel

Another exemplary aspect is directed to an apparatus comprising a partial mesh network comprising at least a first node and a second node. The partial mesh network comprises means for determining at least one restricted path in a turn model for deadlock-free routing of a data packet from a first node to a second node of the partial mesh network, means for enabling the at least one restricted path ending in the second node, and means for routing the data packet through the at least one restricted path.

Yet another exemplary aspect is directed to anon-transitory computer readable storage medium comprising code, which, when executed by a processor, causes the processor to perform operations for deadlock-free routing in a partial mesh network. The non-transitory computer readable storage medium comprises code for determining at least one restricted path in a turn model for deadlock-free routing of a data packet from a first node to a second node of the partial mesh network, code for enabling the at least one restricted path with a terminating channel ending in the second node, and code for routing the data packet through the terminating channel

### BRIEF DESCRIPTION OF THE DRAWINGS

The accompanying drawings are presented to aid in the description of aspects of the invention and are provided solely for illustration of the aspects and not limitation thereof.

FIGS. 1A-F illustrate a conventional full 2D mesh network and related turn models.

FIGS. 2A-C illustrate conventional partial 2D mesh networks.

FIG. 3 illustrates aspects of an exemplary partial 2D mesh network according to this disclosure.

FIG. 4 illustrates a flow chart of a method of deadlock-free routing in a partial mesh network, according to disclosed aspects.

FIG. 5 depicts an exemplary computing device in which an aspect of the disclosure may be advantageously employed.

### DETAILED DESCRIPTION

Aspects of the invention are disclosed in the following description and related drawings directed to specific aspects of the invention. Alternative aspects may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any aspect described herein as “exemplary” is not necessarily to be construed as preferred or advantageous over other aspects. Likewise, the term “aspects of the invention” does not require that all aspects of the invention include the discussed feature, advantage or mode of operation.

The terminology used herein is for the purpose of describing particular aspects only and is not intended to be limiting of aspects of the invention. As used herein, the singular forms “a,” “an,” and “the” are intended to include the plural forms as well, unless the context clearly indicates otherwise. It will be further understood that the terms “comprises”, “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequences of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the aspects described herein, the corresponding form of any such aspects may be described herein as, for example, “logic configured to” perform the described action.

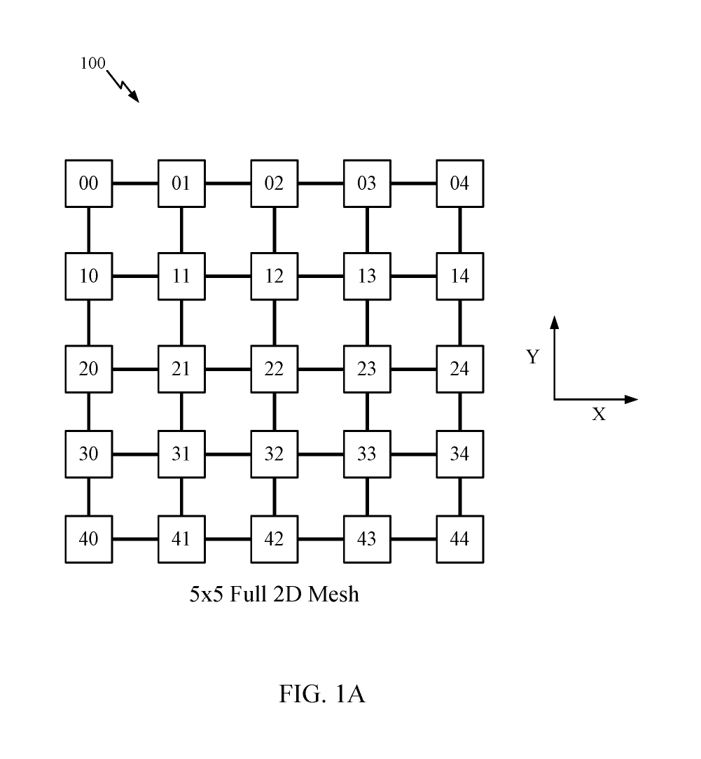

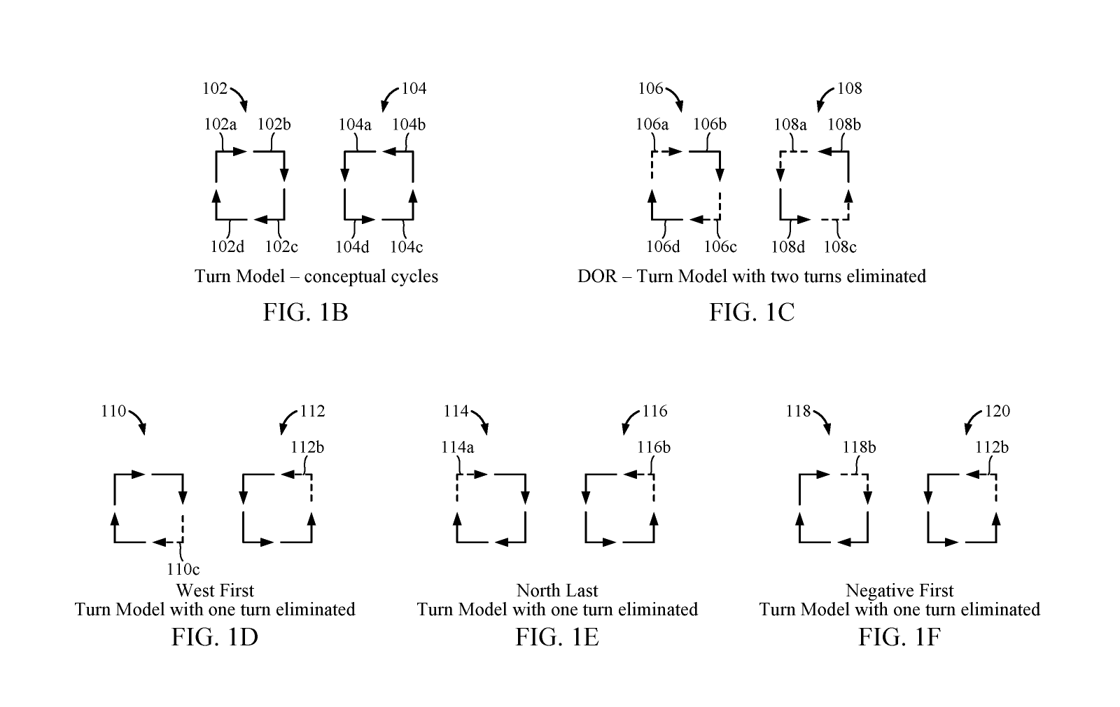

In aspects of this disclosure, exemplary partial 2D mesh networks are configured with the ability to enable restricted turns in the above-described turn models (e.g., DOR of FIG. 1C with two restricted turns or the turn models of FIGS. 1D-F with two restricted turns). Enabling a restricted turn in this disclosure comprises removing restrictions placed by the turn model, or in other words, converting a restricted turn into an unrestricted turn which may be used in routing a data packet through the partial 2D mesh network. In this regard, a terminating channel is disclosed for an implantation of enabling a restricted turn, wherein the terminating channel may be physical or virtual in different implementations. The terminating channel is provided as an exemplary path option in the final leg of a data packet's path to its destination, wherein the terminating channel would have been restricted in conventional turn models. In this manner, a data packet is enabled to make the restricted turn by switching, in the last leg, from an allowed path to the terminating channel. It is noted that since the terminating channel, by definition, is terminating in this disclosure, a data packet which is routed on to the terminating channel is ensured to be free from having a dependency on a data packet traversing on the allowed channels of a partial 2D mesh network, and hence, cycles or deadlocks may be prevented.

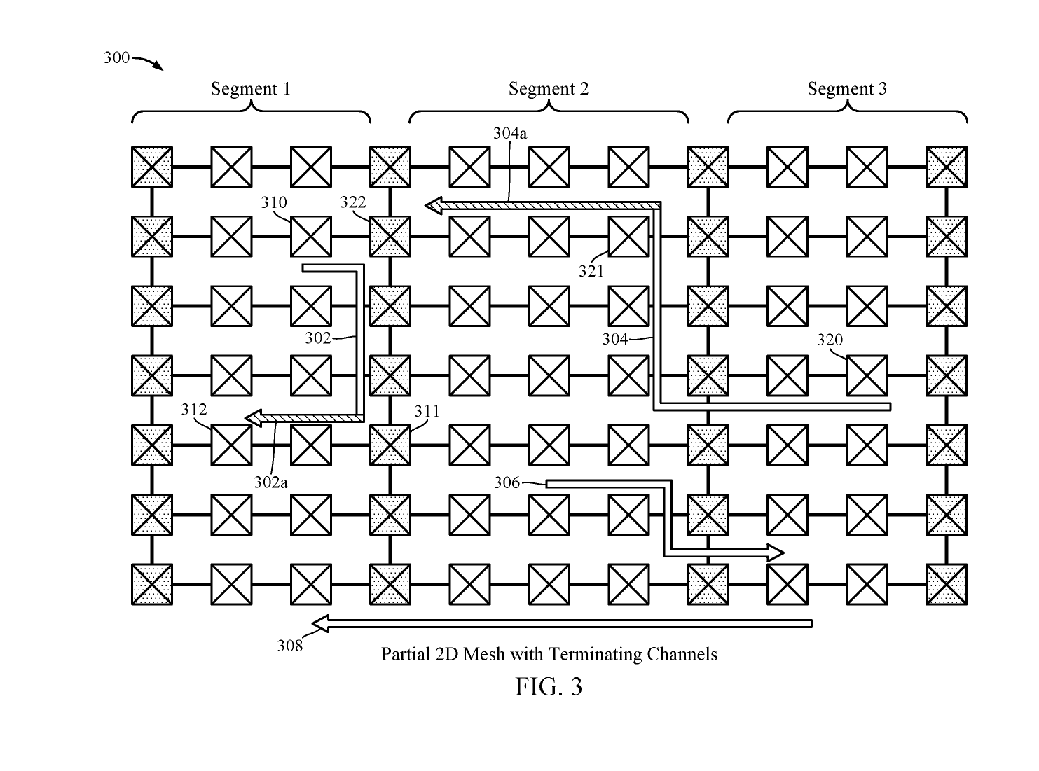

With reference to FIG. 3, an exemplary partial 2D mesh network 300 is shown with terminating channels to prevent deadlocks. Partial 2D mesh network 300 may be integrated in a processing system or SoC and configured for the routing of data packets across its nodes. Partial 2D mesh network 300 may be conceptually viewed as comprising two networks, purely for the sake of explanation, but not to be construed as a limitation or implementation requirement. One of the two component conceptual networks of partial 2D mesh network 300 may be a conventional component which supports a conventional turn model, such as those described with reference to FIGS. 1B-F (e.g., a DOR of FIG. 1C with two restricted turns or any one of twelve variations similar to those shown in FIGS. 1D-F with one restricted turn). A second component conceptual network of partial 2D mesh network 300 may include the exemplary terminating channels. In FIG. 3, partial 2D mesh network 300 is shown with three segments, which is once again merely for the sake of illustration of one example but is not meant to convey any inherent limitations.

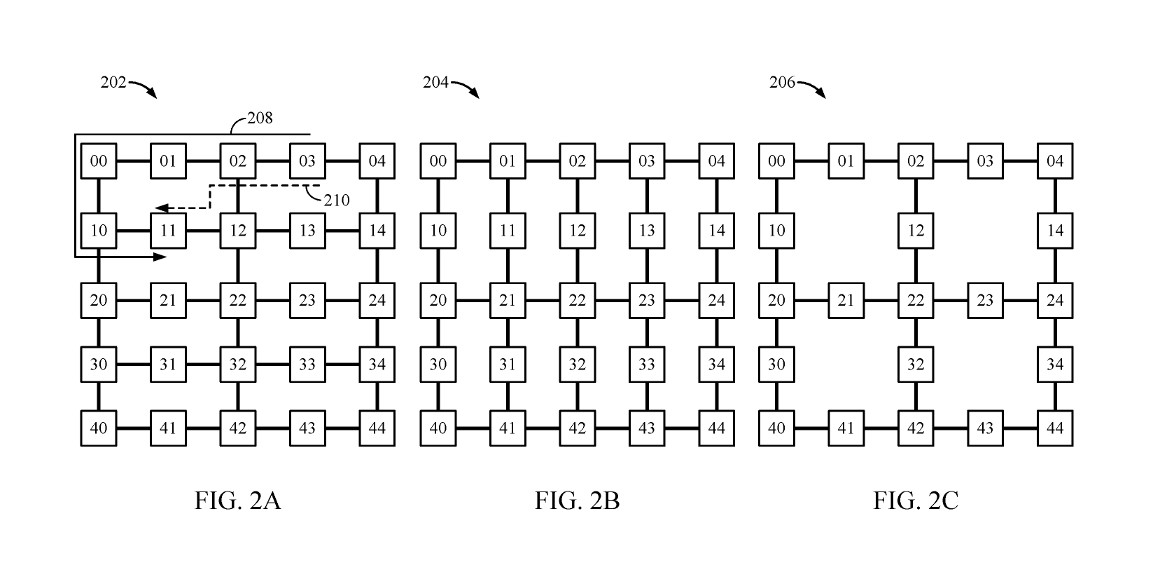

To explain aspects of the terminating channel, turn models with a single turn restriction (e.g., one of twelve variations similar to the west first model of FIG. 1D, north last model of FIG. 1E, or the negative first model of FIG. 1F) will be considered as a starting point. Turn models with a single turn restriction offer greater path diversity than the DOR with two turn restrictions, for example. Greater path diversity leads to better load balancing potential among different paths on which data may be transported on partial 2D mesh network 300. As previously noted, conventional implementations of partial 2D mesh networks 202, 204, 206 of FIGS. 2A-C do not allow some turn restrictions designed to prevent deadlocks (e.g., partial 2D mesh network 202 does not allow an efficient implementation of west first to allow the minimal path 210, as noted in the previous sections; similarly, west first, as well as north last models are also not supported to provide full connectivity in partial 2D mesh network 202, 204, and 206)

In an exemplary aspect, the restricted turns which are not conventionally supported may be enabled by the use of a terminating channel. In exemplary aspects, configuration or related control information for enabling the terminating channels as disclosed herein, may be provided within a packet traversing the exemplary partial 2D mesh network 300. In some aspects, at least a subset of nodes in partial 2D mesh network 300 may be configured to support the use of terminating channels, e.g., based on a look-up table (not shown) or similar information provided within the subset of nodes to support the channeling data through the restricted turns. Various other implementations are also possible for supporting the exemplary aspects related to restricted turns being enabled, as will be recognized by skilled persons, without departing from the scope of this disclosure.

For example, path 302 from a first node, node 310 to a second node, node 312 in segment 1 of partial 2D mesh network 300 is first considered. In path 302, the last leg 302a would be a restricted path which would not be allowed due to the above-described turn restriction in a west first model (e.g., see restricted turn 110c of FIG. 1D). However, in an exemplary aspect, the last leg 302a is enabled for path 302 by using a terminating channel ending in the second node, node 312. In this case, the physical wires for the last leg 302a are shown to be present between a third node 311 and the second node 312, and so the terminating channel is referred to as a terminating physical channel. If the last leg 302a was not allowed, per a conventional implementation using the west first model, then path 302 would have resulted in a more circuitous route to reach node 312 (e.g., similar to the longer path 208 described in FIG. 2A). In FIG. 3, the last leg 302a may be used as a terminating channel under the condition that a data packet routed on the last leg 302a does not have a dependency on any other packets on partial 2D mesh network 300, to ensure that a cycle is not formed.

Similarly, considering path 304 from a first node, node 320 to a second node, node 322, the turn to make the last leg 304a possible from a third node, node 321 to the second node, node 322 would be restricted by the various turn models (e.g., restricted turn 112b in the west first model of FIG. 1D; it is noted that this turn would also be restricted similar to restricted turn 116b in the north last model of FIG. 1E; and restricted turn 120b in the negative first model of FIG. 1F). However, with the use of a terminating channel such as a TPC in the last leg 304a, the restricted turn may be enabled in an exemplary aspect, allowing a shorter path for path 304.

In alternative aspects, the terminating channels for last legs 302a and 304a may be configured with a virtual channel, referred to as a terminating virtual channel (TVC). A virtual channel may be implemented with dedicated buffers within each node but may use the same physical channel For instance, for the last leg 302a, a virtual channel may be created with the use of buffers in each node that the last leg 302a traverses (including nodes 311 and 312), which provides an alternative path for the transmission of a data packet from node 311 to node 312. For example, in the case of contention with another packet transmission, the data packet may be stored in the buffers which are configured to queue the data packet prior to transmission. Thus, no additional physical wires are added in the creation of the virtual channels in exemplary aspects. Further, it is also noted that in the implementation of the virtual channels using the buffers, the virtual channels in partial 2D mesh network 300 may be independent from one another and packets transmitted on one virtual channel may be independent from packets simultaneously transmitted on another virtual channel, even if they traverse common nodes (e.g., there may be two or more independent terminating virtual channels between the same two nodes).

The use of virtual channels for implementations of terminating channels may be less expensive adding dedicated physical channels which may entail dedicated additional wiring between nodes. However, in some cases, a dedicated physical channel may support higher frequency operations since data packets need not be queued in the buffers as in the case of virtual channels for transmission in the terminating channel. A combination of virtual channels and dedicated physical channels is also possible in some implementations of partial 2D mesh network 300.

In an aspect wherein a turn model such as a west first turn model is chosen as a baseline algorithm for routing data packets in partial 2D mesh network 300, support for terminating channels (virtual and/or physical terminating channels) may be provided in only a subset of paths between the various nodes, to minimize resource costs. For instance, since in the west first model, the restricted turn which is enabled by the terminating channel (e.g., last legs 302a, 304a) are in the horizontal direction, support for the terminating channel (e.g., physical wires for a dedicated physical terminating channel or buffers for a virtual terminating channel) may be provided for a subset of nodes which would allow a horizontal traversal, while such support need not be added to vertical paths.

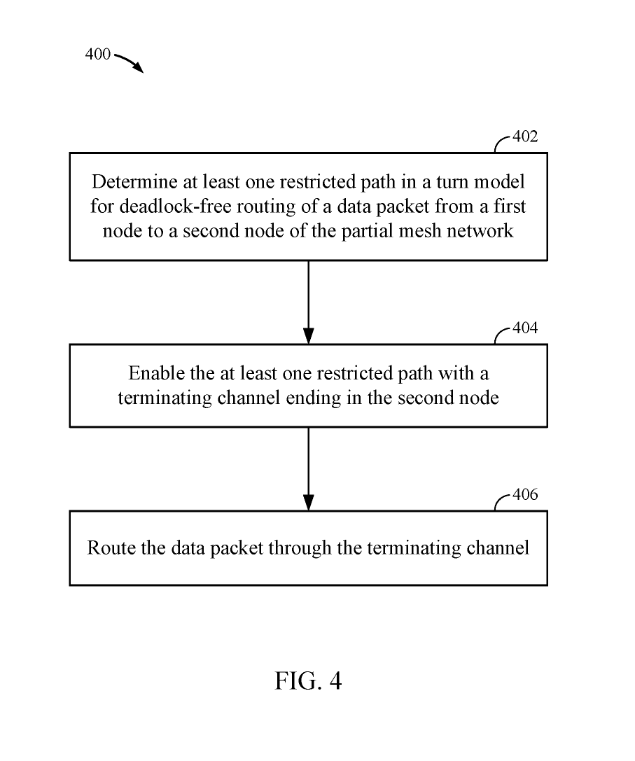

Accordingly, it will be appreciated that exemplary aspects can include various methods for performing the processes, functions, or algorithms disclosed herein. For example, as illustrated in FIG. 4, an exemplary aspect can include a method (400) of deadlock-free routing in a partial mesh network (e.g., partial 2D mesh network 300).

Block 402 comprises determining at least one restricted path in a turn model for deadlock-free routing of a data packet from a first node to a second node of the partial mesh network (e.g., last legs 302a, 304a are restricted paths in a west first turn model).

Block 404 comprises enabling the at least one restricted path with a terminating channel ending in the second node (e.g., creating terminating channels—physical or virtual—in last legs 302a, 304a, ending in nodes 312, 322, respectively).

Block 406 comprises routing the data packet through the terminating channel (e.g., paths 302, 304, which comprise minimal distances from nodes 310 to 312 and 320 to 322, respectively).

As previously mentioned, the restricted path which is enabled in the above aspects of method 400 may be restricted turns in corresponding turn models such as west first, north last, or a negative first turn model. In exemplary aspects, a minimal distance (e.g., paths 302/304) from the first node to the second node in the partial mesh network includes the terminating channel (e.g., 302a/304a respectively) through the restricted path. Further, the abovementioned terminating channels (e.g., 302a/304a) can comprises a terminating physical channel or a terminating virtual channel between a third node (e.g., node 311/321) and the second node (e.g., node 312/322, respectively). The terminating virtual channel can include one or more buffers in at least one of the third node or the second node for queueing the data packet prior to transmission (e.g., to resolve contentions), and also provide the ability for two or more independent terminating virtual channels to be formed between the second node and the third node.

In exemplary aspects, enabling the restricted paths with the terminating channel ending in the second node (e.g., node 312/322, respectively) may be based on routing information contained in the data packet (e.g., within a packet header). Alternatively, or additionally, enabling the at least one restricted path with the terminating channel ending in the second node may be based on routing information contained in at least a subset of nodes of the partial mesh network (e.g., any one or more of the above-described nodes in the three segments of the partial 2D mesh network 300).

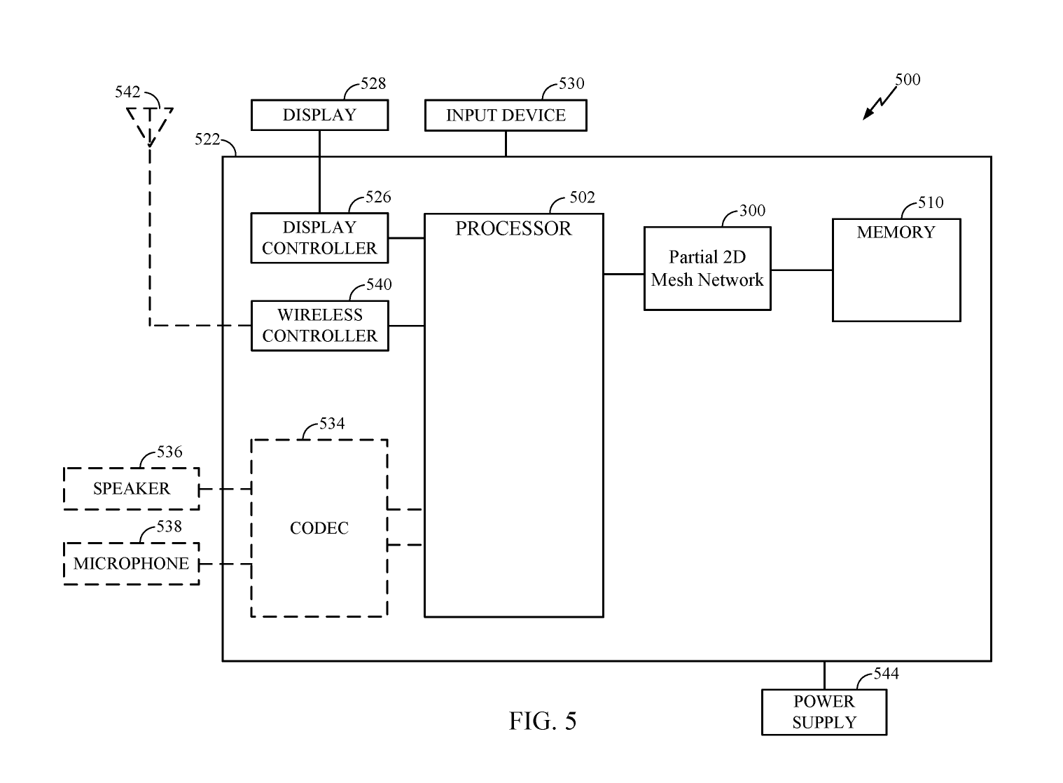

An example apparatus in which exemplary aspects of this disclosure may be utilized, will now be discussed in relation to FIG. 5. FIG. 5 shows a block diagram of computing device 500. Computing device 500 may correspond to an exemplary implementation of a processing system which may be configured to implement method 400 of FIG. 4. In the depiction of FIG. 5, computing device 500 is shown to include processor 502 connected to memory 510 by means of partial 2D mesh network 300 discussed with relation to FIG. 3. It will be understood that this is merely for the sake of illustration, and partial mesh networks of this disclosure may be integrated in any other component of computing device 500. As shown, partial 2D mesh network 300 may serve as a data bus and/or interface unit for transmission of data packets between at least processor 502 and memory 510. As previously mentioned, partial 2D mesh network 300 is configured to enable the at least one restricted path with the terminating channel, based on routing information contained in the data packet, at least a subset of nodes of the partial mesh network, or a combination thereof.

information pertaining to exemplary support for enabling some restricted turns may be provided within packets (e.g., in packet headers) transmitted from processor 502 and/or memory 510, or based on provisions such as a table look-up inside at least a subset of nodes of partial 2D mesh network 300.

FIG. 5 also shows display controller 526 that is coupled to processor 502 and to display 528. In some cases, computing device 500 may be used for wireless communication and FIG. 5 also shows optional blocks in dashed lines, such as coder/decoder (CODEC) 534 (e.g., an audio and/or voice CODEC) coupled to processor 502 and speaker 536 and microphone 538 can be coupled to CODEC 534; and wireless antenna 542 coupled to wireless controller 540 which is coupled to processor 502. Where one or more of these optional blocks are present, in a particular aspect, processor 502, display controller 526, memory 110, and wireless controller 540 are included in a system-in-package or system-on-chip device 522.

Accordingly, a particular aspect, input device 530 and power supply 544 are coupled to the system-on-chip device 522. Moreover, in a particular aspect, as illustrated in FIG. 5, where one or more optional blocks are present, display 528, input device 530, speaker 536, microphone 538, wireless antenna 542, and power supply 544 are external to the system-on-chip device 522. However, each of display 528, input device 530, speaker 536, microphone 538, wireless antenna 542, and power supply 544 can be coupled to a component of the system-on-chip device 522, such as an interface or a controller.

It should be noted that although FIG. 5 generally depicts a computing device, processor 502 and memory 510, may also be integrated into a set-top box, a music player, a video player, an entertainment unit, a navigation device, a personal digital assistant (PDA), a fixed location data unit, a server, a computer, a laptop, a tablet, a communications device, a mobile phone, or other similar devices.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an aspect of the invention can include a computer readable media embodying a method for reducing dynamic power consumption of a data bus. Accordingly, the invention is not limited to illustrated examples and any means for performing the functionality described herein are included in aspects of the invention.

While the foregoing disclosure shows illustrative aspects of the invention, it should be noted that various changes and modifications could be made herein without departing from the scope of the invention as defined by the appended claims. The functions, steps and/or actions of the method claims in accordance with the aspects of the invention described herein need not be performed in any particular order. Furthermore, although elements of the invention may be described or claimed in the singular, the plural is contemplated unless limitation to the singular is explicitly stated.

What is claimed is:

1. A method of deadlock-free routing in a partial mesh network, the method comprising:
determining at least one restricted path in a turn model for deadlock-free routing of a data packet from a first node to a second node of the partial mesh network;
enabling the at least one restricted path with a terminating channel ending in the second node; and
routing the data packet through the terminating channel

2. The method of claim 1, wherein the restricted path comprises a restricted turn in the turn model.

3. The method of claim 1, wherein a minimal distance from the first node to the second node in the partial mesh network includes the terminating channel through the restricted path.

4. The method of claim 1, wherein the terminating channel comprises a terminating physical channel between a third node and the second node.

5. The method of claim 1, wherein the terminating channel comprises a terminating virtual channel between a third node and the second node.

6. The method of claim 5, wherein the terminating virtual channel comprises one or more buffers in at least one of the third node or the second node for queueing the data packet prior to transmission.

7. The method of claim 6, comprising two or more independent terminating virtual channels between the second node and the third node.

8. The method of claim 1, wherein the turn model comprises one of a west first, north last, or a negative first turn model.

9. The method of claim 1, wherein enabling the at least one restricted path with the terminating channel ending in the second node is based on routing information contained in the data packet.

10. The method of claim 1, wherein enabling the at least one restricted path with the terminating channel ending in the second node is based on routing information contained in at least a subset of nodes of the partial mesh network.

11. An apparatus comprising:
a partial mesh network comprising at least a first node and a second node, wherein the partial mesh network is configured to
determine at least one restricted path in a turn model for deadlock-free routing of a data packet from the first node to the second;
enable the at least one restricted path with a terminating channel ending in the second node; and
route the data packet through the terminating channel.

12. The apparatus of claim 11, wherein the restricted path comprises a restricted turn in the turn model.

13. The apparatus of claim 11, wherein a minimal distance from the first node to the second node in the partial mesh network includes the terminating channel through the restricted path.

14. The apparatus of claim 11, wherein the partial mesh network further comprises a third node, and wherein the terminating channel comprises a terminating physical channel between the third node and the second node.

15. The apparatus of claim 11, wherein the partial mesh network further comprises a third node, and wherein the terminating virtual channel comprises a terminating virtual channel between the third node and the second node.

16. The apparatus of claim 15, wherein the terminating virtual channel comprises one or more buffers in at least one of the third node or the second node, the one or buffers configured to queue the data packet prior to transmission.

17. The apparatus of claim 16, wherein the partial mesh network comprises two or more independent terminating virtual channels between the second node and the third node.

18. The apparatus of claim 11, wherein the turn model comprises one of a west first, north last, or a negative first turn model.

19. The apparatus of claim 11, wherein the partial mesh network is configured to enable the at least one restricted path with the terminating channel ending in the second node, based on routing information contained in the data packet, at least a subset of nodes of the partial mesh network, or a combination thereof.

20. The apparatus of claim 11, integrated in a device selected from the group consisting of a set-top box, a music player, a video player, an entertainment unit, a navigation device, a personal digital assistant (PDA), a fixed location data unit, a server, a computer, a laptop, a tablet, a communications device, and a mobile phone,.

21. An apparatus comprising:
a partial mesh network comprising at least a first node and a second node, the partial mesh network comprising:
means for determining at least one restricted path in a turn model for deadlock-free routing of a data packet from a first node to a second node of the partial mesh network;
means for enabling the at least one restricted path ending in the second node; and
means for routing the data packet through the at least one restricted path.

22. A non-transitory computer readable storage medium comprising code, which, when executed by a processor, causes the processor to perform operations for deadlock-free routing in a partial mesh network, the non-transitory computer readable storage medium comprising:
code for determining at least one restricted path in a turn model for deadlock-free routing of a data packet from a first node to a second node of the partial mesh network;
code for enabling the at least one restricted path with a terminating channel ending in the second node; and
code for routing the data packet through the terminating channel.

23. The non-transitory computer readable storage medium of claim 22, wherein the restricted path comprises a restricted turn in the turn model.

24. The non-transitory computer readable storage medium of claim 22, wherein a minimal distance from the first node to the second node in the partial mesh network includes the terminating channel through the restricted path.

25. The non-transitory computer readable storage medium of claim 22, wherein the terminating channel comprises a terminating physical channel between a third node and the second node.

26. The non-transitory computer readable storage medium of claim 22, wherein the terminating channel comprises a terminating virtual channel between a third node and the second node.

27. The non-transitory computer readable storage medium of claim 26, wherein the terminating virtual channel comprises one or more buffers in at least one of the third node or the second node and code for queueing the data packet in the one or more buffers, prior to transmission.

28. The non-transitory computer readable storage medium of claim 22, wherein the turn model comprises one of a west first, north last, or a negative first turn model.

29. The non-transitory computer readable storage medium of claim 22, wherein code for enabling the at least one restricted path with the terminating channel ending in the second node is based on routing information contained in the data packet.

30. The non-transitory computer readable storage medium of claim 22, wherein code for enabling the at least one restricted path with the terminating channel ending in the second node is based on routing information contained in at least a subset of nodes of the partial mesh network.
